(19) United States
(12) Patent Application Publication
(10) Pub. No.: US 2006/0043078 A1
(43) Pub. Date: Mar. 2, 2006

(54) Apparatus for observing and controlling a laser machining process

(75) Inventors: Jorg Bernges, Gaggenau (DE); Bert Schurmann, Gernsbach (DE)

Correspondence Address: BIRCH STEWART KOLASCH & BIRCH, PO BOX 747, FALLS CHURCH, VA, 22040-0747, US

(73) Assignee: Precitec KG, Gaggenau-Bad Rotenfels (DE)

(21) Appl. No.: 11/211,731

(22) Filed: Aug. 26, 2005

(30) Foreign Application Priority Data
Aug. 30, 2004 (DE) 10 2004 041 935.3

(51) Int. Cl. B23K 26/03

(52) U.S. Cl. 219/121.83

(57) ABSTRACT

An apparatus for observing and controlling a laser machining process. A working laser beam is focused in an interaction zone on a workpiece by means of a focusing mirror. The apparatus includes a radiation-sensitive receiver arrangement, and an observation mirror which deflects radiation coming from a region of the interaction zone and couples the radiation out of a working beam path onto the receiver arrangement. The observation mirror has substantially the same imaging properties as the focusing mirror. In addition, an evaluation circuit is provided to which output signals from the receiver arrangement of the observation apparatus are supplied, which processes the output signals received from the receiver arrangement and which supplies output signals for an open-loop and closed-loop control circuit, which in turn controls the laser beam and/or the laser machining process as a function of the output signals from the evaluation circuit.

### BACKGROUND OF THE INVENTION

1. Field of the Invention

This invention relates to an apparatus for observing a laser machining process, and to an apparatus for controlling the laser machining process on the basis of observed results.

2. Discussion of the Background

For the purpose of process observation, process monitoring and process control during laser machining, in particular during laser beam cutting, use is made of sensor and monitoring apparatuses which use photodiodes or CCD image sensors as radiation-sensitive sensors. These observe, register and if appropriate record the optical emissions from the interaction zone between the laser beam and workpiece during the machining process.

For this purpose, inter alia external systems are used which use sensors fitted externally to a laser machine head. For example two-dimensional cameras (such as CCD image sensors with receiver elements arranged over an area), line cameras (such as CCD image sensors with receiver elements arranged in lines), or photodiode systems may be used. These sensors are assigned their own imaging optics and protective apparatuses.

DE 100 13 892 A1 discloses such an external apparatus for determining the welding quality of a weld between workpieces. The apparatus comprises first and second sensor devices which are both connected to a measuring apparatus and which register the emission intensity of light which is emitted laterally from the weld at different angles.

In addition to external systems for observing and monitoring laser machining operations, systems are also used in which, at least individual elements of the working laser beam guidance system within a laser machining head are used for the transport of the radiation from the interaction zone between laser beam and workpiece to the radiation-sensitive receivers.

For example, DE 101 20 251 A1 discloses a method and a sensor apparatus for observing and monitoring a laser machining operation to be carried out on a workpiece, in which the process radiation from the interaction region between laser beam and workpiece passes via a focusing lens for the working laser beam to a splitter mirror so that the radiation coming from the interaction zone is coupled out of the working beam path. Imaging optics arranged downstream of the splitter mirror then focus the radiation on to a locally resolving receiver arrangement, which has a mask to determine an observation field on the workpiece.

DE 101 60 623 A1 relates to a further apparatus for observing and monitoring a laser machining operation, which is used with a laser machine head in which a collimated working laser beam is deflected by a deflection mirror onto a hollow mirror serving as focusing optics. In this case, the focusing optics have an effective opening which is larger than that of the deflection mirror. Thus, part of the radiation coming from the interaction zone between the laser beam and the workpiece which strikes the focusing mirror is led annularly past the deflection mirror and can be focused onto an entry mask of the receiver arrangement by a convergent lens arranged behind the deflection mirror. If, in this case the distance between the mask and the connecting lens is varied, the observation region in the region of the interaction zone is displaced in a corresponding way.

This arrangement is suitable for the integral measurement of process radiation of specific wavelength ranges. In this case, however, because of the imaging errors of the focusing mirror, sharp imaging of the workpiece surface around the interaction zone is not possible.

In addition to these sensor and monitoring apparatuses which use imaging elements of the working beam path for beam guidance, DE 198 52 302 A1 discloses a process monitoring device in which a focusing mirror for the working laser beam is provided with a hole, through which the radiation originating from the interaction zone between the laser beam and workpiece can pass in order to be deflected onto a detector by optics arranged behind the hole. In this case, although the detector can be arranged in the laser machining head, no optical elements of the working laser beam path as such are used for observing the machining process.

Furthermore, this observation beam path has a very limited opening which nevertheless permits keyhole observation of the interaction zone.

DE 41 06 008 discloses an apparatus for monitoring a laser machining operation in which a working laser beam is focused onto a workpiece in an interaction zone via a large number of deflection mirrors and a focusing mirror. The optical radiation originating from the region of the interaction zone is led back conversely from the focusing optics via the deflection mirror and strikes what is known as a scraper mirror, which is an annular deflection mirror which surrounds the working laser beam. The scraper mirror deflects an annular parallel bundle of rays onto a corresponding receiver arrangement.

### SUMMARY OF THE INVENTION

On this basis, the present invention has as an objective to provide a further apparatus for observing a laser machining process with which qualitatively good imaging of the surface of a workpiece in the region of the interaction zone coaxially through the beam path is made possible, so that in particular the imaged region can be recorded by means of a camera. A further object is to provide an apparatus for controlling a laser machining process which uses a qualitatively good image of the workpiece surface.

According to the present invention, therefore, an observation apparatus for a laser machining process, in which a working laser beam is focused into an interaction zone on a workpiece by means of a focusing mirror, has a regulation-sensitive receiver arrangement and an observation mirror which deflects the radiation coming from a region of the interaction zone and is coupled out of a working beam path onto the receiver arrangement, the observation mirror having substantially the same imaging properties as the focusing mirror.

With such an arrangement, a coaxial process observation becomes possible, so that no specific observation optics need to be mounted in the region of or close to the interaction zone. The use of two mirrors, namely the focusing mirror and the observation mirror, which have substantially the same imaging properties, permits compensation of the imaging errors, such as the cancellation of the imaging errors of the one mirror by means of the intrinsically faulty imaging of the other mirror.

In a particularly advantageous refinement of the invention, provision is made for both the focusing mirror and the observation mirror to be paraboloid or ellipsoid mirrors, which preferably have the same focal length.

Particularly clear and distinct imaging of the region around the interaction zone results if the observation mirror is arranged in such a way that the deflection by the observation mirror of the radiation coming from the region of the interaction zone is carried out in the same direction as by the focusing mirror.

In principle, the radiation coming from the region of the interaction zone can be coupled out of the working beam path with the aid of a dichroic deflection mirror or else by means of a planar scraper mirror acting as a deflection mirror, i.e. a mirror surrounding the working laser radiation annularly, while the imaging observation mirror is provided outside the region of the working beam path.

A preferred exemplary embodiment of the invention is, however, distinguished by the fact that an annular observation mirror (scraper mirror) is arranged in the working beam path and annularly surrounds the working laser beam running to the focusing mirror, in order to couple radiation coming from the region of the interaction zone out of the working beam path.

The use of the observation mirror formed as a scraper mirror for coupling the radiation coming from the region of the interaction zone out of the working beam path and for imaging the region of the interaction zone onto the receiver arrangement permits further simplification of the construction and the integration of the observation apparatus according to the invention, in particular if the observation mirror images an observation field in the region of the interaction zone directly onto the receiver arrangement without further interposed imaging elements.

In a particularly expedient refinement of the invention, provision is made for the receiver arrangement to comprise a mask for determining the observation field in the region of the interaction zone and a photosensor arranged behind said mask.

In this way, therefore, the observation field or the measured area on the workpiece surface can be adapted to the respective machining process. For example, in the case of a welding operation, the temperature of the solidifying or solidified melt following the machining operations can be measured; the keyhole, the actual interaction region between the working laser beam and workpiece, can be masked out, or an area on the workpiece which can be shaped virtually as desired can be registered as an observation field.

A particularly advantageous refinement of the invention is distinguished by the fact that the receiver arrangement comprises an imaging photosensor, the imaging photosensor being a solid-state image sensor, preferably a solid-state image sensor having a two-dimensional pixel array.

The use of an imaging photosensor in the receiver arrangement of the observation apparatus according to the invention, in particular the use of a solid-state image sensor having a two-dimensional photocell array, makes it possible not only to present the interaction zone and the region around the latter on a monitor to an operator or maintenance engineer, but is also suitable for image processing with which, for example in the case of a welding process, the melt bath can be registered in terms of length, width and orientation, in order to be able to draw conclusions about the quality of the machining process from this, from which information for the control of the machining process can then be derived.

If, for example during welding, the melt bath length is too short, or its width is too great, then this points to an excessively low feed speed or to an excessively high laser output, which can result in holes in the weld. Conversely, an excessively small width of the melt bath or an excessively great length points to an excessively high feed speed, which can likewise lead to a deficient weld.

Controlling a laser machining process as a function of the observed results is expediently carried out by means of a control apparatus which has an apparatus for observing the laser machining process and an evaluation circuit, to which output signals from the receiver arrangement of the observation apparatus are supplied, which processes the received output signals from the receiver arrangement and which, for its part, supplies output signals for an open-loop or closed-loop control circuit, which controls the laser beam and/or the laser machining process as a function of the output signals from the evaluation circuit.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is a simplified schematic illustration of a laser machine head with an apparatus for observing a laser machining process according to the present invention;

FIGS. 2a and 2b are highly simplified schematic illustrations of various possible ways of deflecting the beam in the observation beam path of the present invention; and

FIG. 3 is a sectional illustration of the observation apparatus according to the invention.

### DETAILED DESCRIPTION OF THE PREFERRED EMBODIMENTS

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

As FIG. 1 illustrates, the apparatus according to the invention for observing a laser machining process has a radiation-sensitive receiver arrangement 10, which is fitted to a housing 11 of a laser machining head 12 or is integrated in the latter. An observation mirror 13, which is formed as a focusing aspherical annular mirror is arranged in a working beam 14′ which is led through the laser machining head 12 such that it surrounds a working laser beam 14 annularly. The working laser beam 14 in the exemplary embodiment illustrated is deflected via a deflection mirror 15 onto a focusing mirror 16, which focuses the working laser beam 14 into an interaction zone 17 on a workpiece 18, in order to carry out a laser machining process, such as laser cutting, laser welding, powder coating or the like.

In the opposite direction, radiation, in particular optical radiation and light from the interaction zone 17 and a region surrounding the latter is led back by the focusing mirror 16 via the deflection mirror 15 along the working beam path 14′ to the observation mirror 13. The observation mirror 13 couples the light originating from the region of the interaction zone 17 out of the working beam path 14′ and images it onto the radiation-sensitive receiver arrangement 10.

In order in this case to obtain a sharp image of a workpiece surface in the region of the interaction zone 17, the observation mirror 13 and the focusing mirror 16 are formed in such a way that they have substantially the same imaging properties. If paraboloid mirrors, which preferably have the same focal lengths, are used for both the observation mirror 13 and the focusing mirror 16, then the magnitudes of the imaging errors of the two mirrors are also of the same size. Since the imaging errors depend not only on the focal length but also on the orientation of the paraboloid mirrors, it is possible, with a suitable arrangement of observation mirror 13 and focusing mirror 16, for the imaging errors to cancel one other, and a sharp image of the workpiece surface is obtained. Instead of paraboloid mirrors, other aspherical mirrors, for example ellipsoid mirrors, can also be used.

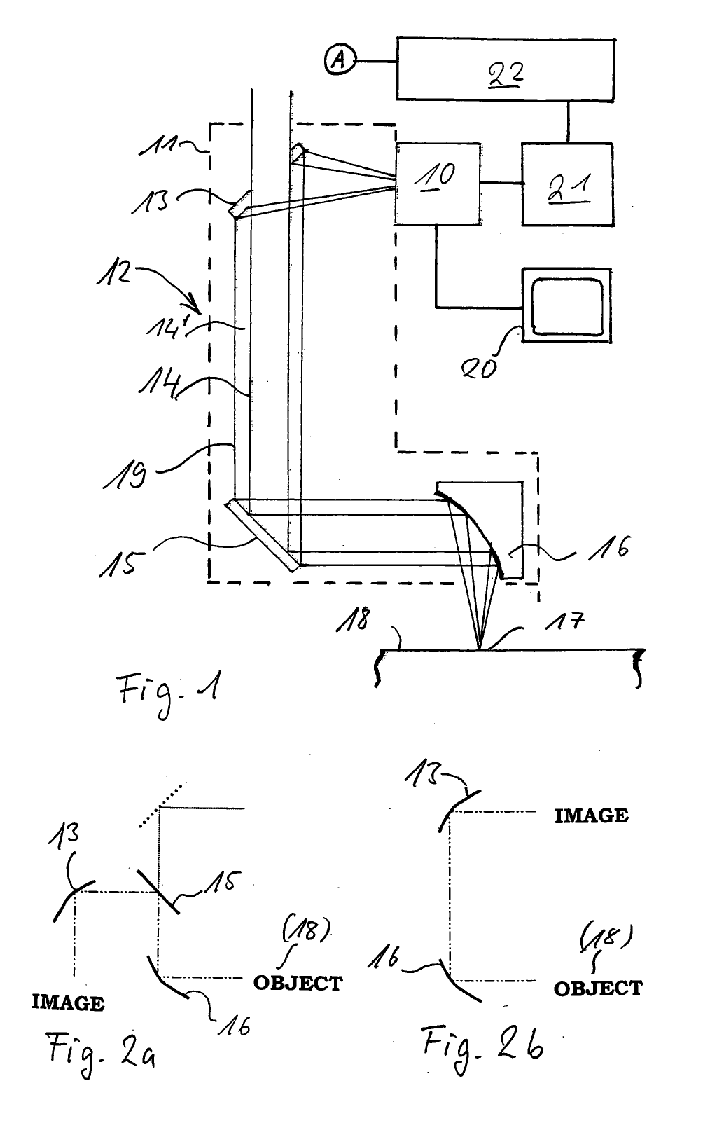

FIG. 2a shows schematically in simplified form the arrangement of the focusing mirror 16, deflection mirror 15 and observation mirror 13 in accordance with FIG. 1, from which it can be seen that the deflections of the two imaging mirrors take place in the same direction. In this case, the imaging errors cancel one another out, since they are oriented in opposite directions.

A sharp image of the object is therefore obtained of the surface of the workpiece 18, but which is mirror-inverted because of the deflection mirror 15 arranged between focusing mirror 16 and observation mirror 13.

FIG. 2b shows in schematic form the arrangement of observation mirror 13 and focusing mirror 16 without an interposed deflection mirror. In this arrangement, a sharp image of the object is produced of the workpiece surface in the region of the interaction zone 17.

If a camera, for example a video camera, is now used as a receiver arrangement 10, then the image recorded can be displayed on a monitor 20 for the immediate observation of the machining process. Alternatively or additionally, the recorded image data can also be supplied to an appropriate evaluation circuit, which processes the image signals or other signals supplied by the receiver arrangement 10 in a suitable way in order to supply suitable status signals which can be used for quality assurance and for open-loop or closed-loop control of a laser machining machine. Status signals of this type can be supplied to an open-loop or closed-loop control circuit 22, which supplies corresponding control signals for the operation of a laser machining machine, in whose laser machining head 12 the present apparatus for observing the laser machining process is integrated.

The evaluation circuit 21 and the open-loop or closed-loop control circuit 22 are illustrated as separate function blocks in the drawing. However, they can also be formed as a unit, both in terms of circuitry and in terms of function. In this case, for example, it is also possible, if a correspondingly suitable receiver arrangement is used, to use the output signal from the receiver arrangement 10 directly as an input signal for an open or closed control loop.

Furthermore, in particular for quality assurance, it is possible to record the output signals from the receiver arrangement 10 during the machining process, in order to be able subsequently still to detect faults in the machining process or to document the fault-free course of the machining process.

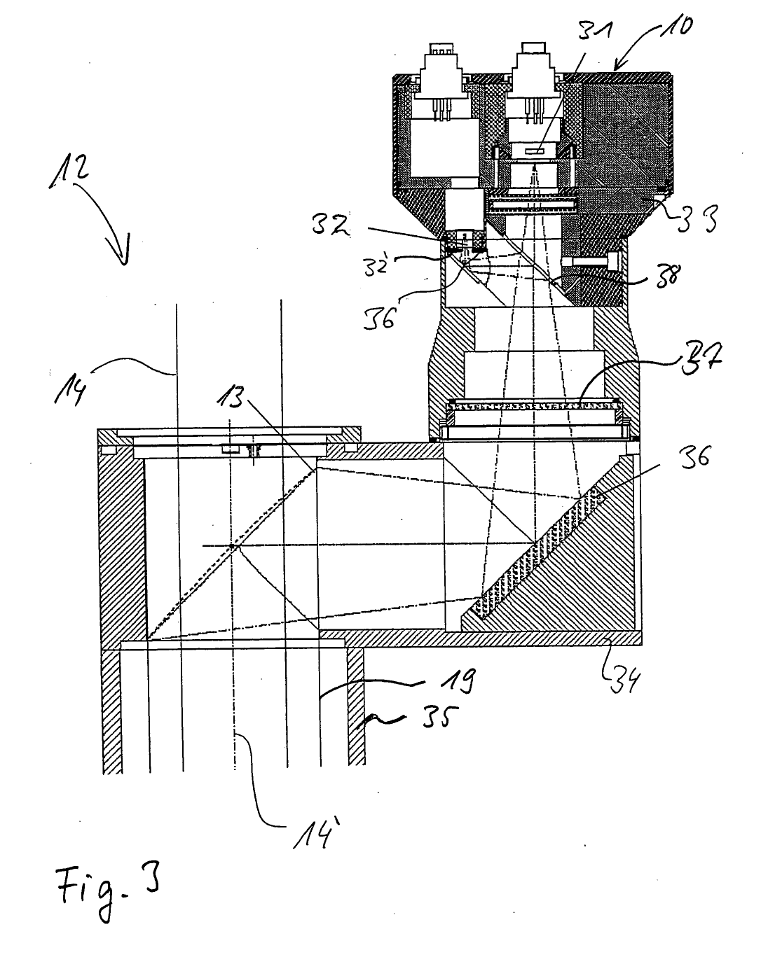

FIG. 3 shows the observation apparatus according to the invention, which has first and second receivers 31, 32 as the receiver arrangement 10. One of the two receivers 31, 32 is in this case preferably formed as a camera receiver, such as a CCD image sensor or the like, in order to supply a sharp image of the surface of the workpiece 18 in the region of the interaction zone 17, which can be displayed immediately and at the same time can also be supplied to suitable image processing. Since the arrangement according to the invention of two aspherical mirrors for imaging the region around the interaction zone 17 onto the receiver arrangement supplies a sharp image, the second receiver 32 can be assigned a mask 32′, indicated only schematically, which defines a specific observation region, such as an observation or measured field on the workpiece surface. In this case, the radiation-sensitive receiver used can be one or more photodiodes with specific spectral sensitivities. In addition, the other receiver 31, which is preferably formed as a camera receiver, can be assigned a suitable mask, for example a mask masking out the interaction zone 17 if regions in front of and/or behind the latter are to be observed.

The receiver arrangement 10 is arranged in a housing 33 which is held via an angled housing 34 on a housing part 35 of the laser machining head 12, through which the working laser beam 14 is led. Here, therefore, the receiver arrangement 10 is accommodated in a housing 33, 34 which is fitted to the housing 11, in particular to the part 35 of the housing 11. In another configuration of the laser machining head, however, it is also conceivable for the observation apparatus with all its elements to be integrated in the housing 11 of the laser machining head 12.

The observation mirror 13, which is indicated throughout by a dashed line in order to indicate the aspherical curvature of the annular observation mirror 13, couples the radiation from the region of the interaction zone 17 out of the working beam 14′ in such a way that it is deflected in the direction of the receiver arrangement 10 via a deflection mirror 36 arranged in the angled housing 34. In the angled housing 34, as viewed in the direction of the light, a protective lens 37 is arranged after the deflection mirror 36 in order to seal off the input region of the receiver arrangement 10 with respect to the interior of the housing 11 of the laser machining head 12.

A splitter mirror 38 lets part of the radiation from the region of the interaction zone 17 and from the region surrounding the latter through to the receiver 31, while another part is reflected and deflected onto the second receiver 32 via a further deflection mirror 49.

The output signals from the two receivers 31, 32, which can be formed as photodiodes for monitoring the process radiation from specific wavelength ranges or as imaging receivers, can in turn be used for a large number of monitoring, open-loop and closed-loop control tasks for quality control and/or for process control. It is possible for appropriate open-loop and closed-loop control signals to be formed from the output signals from the receivers 31, 32 by means of appropriate evaluation, open-loop and/or closed-loop control circuits, so that control of the laser machining process can be carried out with the effect of maintaining and/or improving the machining quality.

In particular, specific parameters of the machining process, such as laser output, feed speed, working distance or the like, can be controlled as a function of the observed results.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for observing a laser machining process, in which a working laser beam is focused in an interaction zone on a workpiece by means of a focusing mirror, the apparatus comprising:
a radiation-sensitive receiver arrangement, and
an observation mirror which deflects radiation coming from a region of the interaction zone and couples the radiation out of a working beam path onto the receiver arrangement, the observation mirror having substantially the same imaging properties as the focusing mirror.

2. The apparatus as claimed in claim 1, wherein the focusing mirror and the observation mirror are both paraboloid mirrors.

3. The apparatus as claimed in claim 1, wherein the focusing mirror and the observation mirror are both ellipsoid mirrors.

4. The apparatus as claimed in claim 1, wherein the focusing mirror and the observation mirror both have the same focal length.

5. The apparatus as claimed in claim 1, wherein the observation mirror is arranged in such a way that the deflection by the observation mirror of the radiation coming from the region of the interaction zone is carried out in the same direction as by the focusing mirror.

6. The apparatus as claimed in claim 1, wherein an annular observation mirror is arranged in the working beam path and annularly surrounds the working laser beam running to the focusing mirror, in order to couple radiation coming from the region of the interaction zone out of the working beam path.

7. The apparatus as claimed in claim 1, characterized in that the observation mirror images an observation field in the region of the interaction zone onto the receiver arrangement.

8. The apparatus as claimed in claim 1, wherein the receiver arrangement comprises a mask for determining an observation field in the region of the interaction zone and a photo sensor arranged behind said mask.

9. The apparatus as claimed in claim 1, characterized in that the receiver arrangement comprises an imaging photosensor.

10. The apparatus as claimed in claim 9, characterized in that the imaging photosensor is a solid-state image sensor having a two-dimensional pixel array.

11. An apparatus for controlling a laser machine process, having
an apparatus for observing the laser machine process including a radiation-sensitive receiver arrangement, and an observation mirror which deflects radiation coming from a region of an interaction zone of a working laser beam focused by a focusing mirror on a workpiece and couples the radiation out of a working beam path onto the receiver arrangement, the observation mirror having substantially the same imaging properties as the focusing mirror, and
an evaluation circuit to which output signals from the receiver arrangement of the observation apparatus are supplied and processed and which, supplies output signals for an open-loop and closed-loop control circuit, which controls the laser beam and/or the laser machining process as a function of the output signals from the evaluation circuit.
